(19) United States
(12) Patent Application Publication
(10) Pub. No.: US 2004/0036699 A1
(43) Pub. Date: Feb. 26, 2004

(54) Method of identifying symbols, and portable electronic device

(75) Inventor: Esa Nettamo, Oulu (FI)

Correspondence Address: Crawford Maunu PLLC, Suite 390, 1270 Northland Drive, St. Paul, MN, 55120, US

(73) Assignee: Nokia Corporation

(21) Appl. No.: 10/603,323

(22) Filed: Jun. 25, 2003

(30) Foreign Application Priority Data
Jun. 25, 2002 (FI) 20021240

(51) Int. Cl. G09G 5/00

(52) U.S. Cl. 345/619

(57) ABSTRACT

The invention relates to a method of identifying symbols in a portable electronic device comprising: a screen, a contact surface and a contact area for symbol creation located. The method comprises detecting (302) the start of a symbol creation function; enlarging (304) the size of the contact area for symbol creation after the start of the symbol creation function and interpreting (310) a symbol created in the enlarged contact area for symbol creation. The invention also relates to a portable electronic device comprising: a screen, a contact surface and a contact area for symbol creation. The device comprises means (100, 106) for: detecting the start of a symbol creation function; enlarging the size of the contact area for symbol creation after the start of the symbol creation function and interpreting a symbol created in the enlarged contact area for symbol creation.

### FIELD

The invention relates to a portable electronic device and a method of identifying symbols. The invention relates to a portable electronic device comprising a touch screen.

### BACKGROUND

In portable electronic devices, touch screens are used to replace the mouse and the keypad, for example. The user gives control commands to the device by touching contact areas visible on the touch screen. In portable electronic devices, such as pocket computers, digital notebooks and mobile telephones, automatic identification of handwritten symbols has become common. Since separate keypads in the devices increase the size of the devices, small electronic devices with only a touch screen as the user interface have become common. Writing directly on the screen of the device is also easier than using a complicated miniature keypad, for example. Several portable devices are thus provided with a feature that identifies handwriting, by means of which the device converts handwritten text, for example, into composed text. The user writes symbols in an area for writing symbols on a touch screen by means of a pen or a finger, for example. The device then identifies the written symbol based on the detected contact points in said area.

The problem in prior art solutions is that the area reserved on the touch screen for writing symbols is small. This makes it hard to write in said area in a moving vehicle, for example. The symbols to be written are hard to make fit in the space reserved for them as the hand shakes in a rush hour bus, for example. However, since a touch screen has to fit several objects at the same time, by touching which the user gives control commands, the size reserved for writing symbols cannot be expanded limitlessly. The fact is that to facilitate the identification of different symbols, the screen can include several areas for creating symbols. Consequently, there may be special areas for writing letters and digits, inside of which areas the writing must fit.

### BRIEF DESCRIPTION

An object of the invention is to provide a method and a device for implementing the method so as to alleviate prior art problems. This is achieved by a method of identifying symbols in a portable electronic device comprising: a screen, a contact surface in the screen area covering at least part of the screen area, and a contact area for symbol creation located in the contact surface area. The method comprises detecting the start of a symbol creation function; enlarging the size of the contact area for symbol creation after the start of the symbol creation function, and interpreting a symbol created in the enlarged contact area for symbol creation.

The invention also relates to a portable electronic device comprising: a screen, a contact surface in the screen area covering at least part of the screen area, and a contact area for symbol creation located in the contact surface area. The device of the invention comprises means for: detecting the start of a symbol creation function; enlarging the size of the contact area for symbol creation after the start of the symbol creation function, and interpreting a symbol created in the enlarged contact area for symbol creation.

The preferred embodiments of the invention are described in the dependent claims.

The method and device of the invention provide a plurality of advantages. The identification of symbols improves also under difficult conditions, such as when the device is used in moving vehicles. More objects fit simultaneously on the screen of the device. The user friendliness of the device also improves, since the accuracy required by the user in creating symbols is not too high.

### LIST OF THE FIGURES

In the following, the invention will be described in detail in connection with preferred embodiments with reference to the accompanying drawings, in which

FIGS. 1A and 1B show devices of the invention,

FIGS. 2A and 2B show details of the screen of a device of the invention, and

FIG. 3 is a block diagram of an embodiment of the invention.

### DESCRIPTION OF THE EMBODIMENTS

The embodiments of the invention are applicable in portable electronic devices, such as a mobile station used as a terminal in telecommunication systems comprising one or more base stations and terminals communicating with the base stations. The device may be used for short-range communication implemented with a Bluetooth chip, an infrared or WLAN connection, for example. The portable electronic device is e.g. a mobile telephone or another device including telecommunication means, such as a portable computer, a handheld computer or a smart telephone. The portable electronic device may be a PDA (Personal Digital Assistant) device including the necessary telecommunication means for establishing a network connection, or a PDA device that can be coupled to a mobile telephone, for instance, for a network connection. The portable electronic device may also be a computer or PDA device not including telecommunication means.

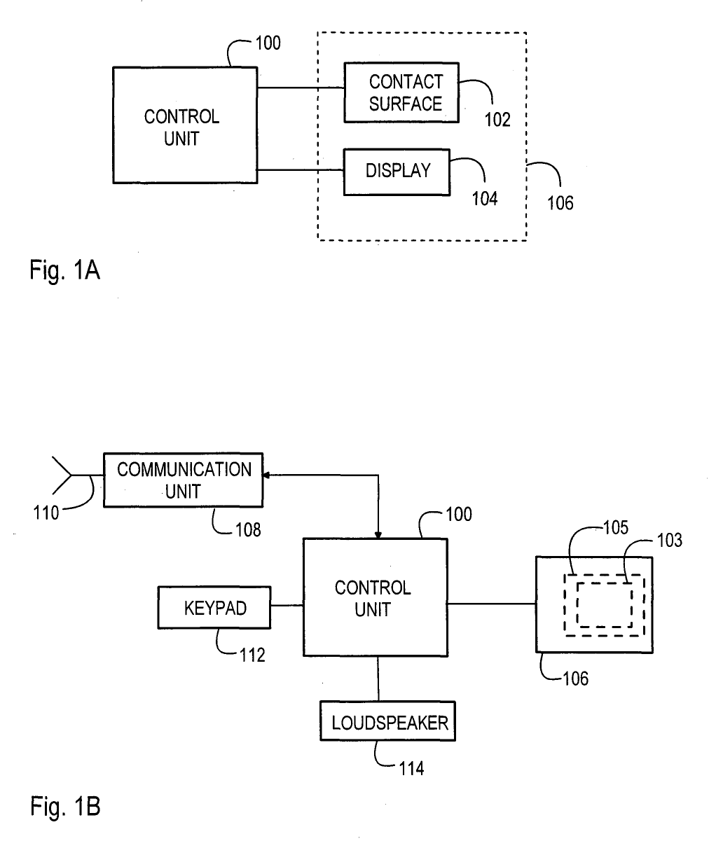

FIG. 1A shows a block diagram of the structure of a portable electronic device. The basic functions of the device are controlled by a control unit 100, typically implemented by means of a microprocessor and software or separate components. The user interface of the device comprises a screen 104 and a contact surface 102, which together constitute a touch screen 106. An alternative is to have only a contact surface 102 and no screen 104 at all. In the touch screen 106, the contact surface 102 is on top of the screen 104. Typically, the screen 104 is a liquid crystal display.

A way to implement the contact surface 102 is based on two overlapping transparent films and continuous electric current, which is generated between the films when the outer film is pressed with a finger or another object against the lower film, which is covered with a resistive layer. The contact surface 102 may also be implemented capacitively, whereby the surface is covered with an electrically conducting layer, over which an alternating current acts. The capacitance of the human body couples part of the voltage at the contact point to ground, allowing the voltage to be measured. The contact surface 102 may also be implemented by means of power sensors. The touch screen 106 may also be implemented by not placing anything on top of the screen 104, but detecting the contact point in some other manner. The touch can be detected for instance acoustically based on ultrasonic waves traversing the surface of the screen. When the screen is touched, the sonic wave traversing the surface is attenuated, and the change can be measured. The contact point may also be detected with infrared light and said ultrasound, but using infrared light instead of sonic waves. The contact surface 102 may also be implemented by means of a projector and cameras, for example. In principle, the contact surface 102 may be any surface on which an image is reflected with a projector and a camera is used to detect the point where the projected image was touched.

FIG. 1B is a block diagram of the structure of a device of the invention. All basic functions of the device, including touch screen functions, are controlled by the control unit 100, typically implemented by means of a microprocessor and software or separate components. The user interface of the device comprises a touch screen 106, which, as mentioned, is the whole formed by the contact surface 102 and the screen 104 shown in FIG. 1A. The touch screen 106 in FIG. 1B is entirely covered with a contact surface. Alternatively, only part of the surface of the screen of the device includes a contact surface. FIG. 1B illustrates contact areas 103, 105 for symbol creation in the area of the touch screen 106, which are implemented by software, for example by means of the control unit 100 and the touch screen 106. In addition, the user interface of the device may include a loudspeaker 114 and a keypad part 112. Depending on the type of device, there may be different and a different number of user interface parts. The device of FIG. 1B, such as a mobile station, also includes conventional means 108 that implement the functions of a mobile station and include speech and channel coders, modulators and RF parts. The device also comprises an antenna 110.

The functions of the device are controlled by means of the touch screen 106 such that the desired functions are selected by touching the desired objects visible on the touch screen 106. The touch is carried out by means of a pen or a finger, for example. The function of identifying written symbols operates such that the desired symbol is created in the contact area 103, 105 for symbol creation in the area of the touch screen 106 using for instance a pen. In order for the control unit 100 of the device to interpret the touch on the contact area for symbol creation as a given symbol, the touch has to hit said contact area 103, 105 for symbol creation when the symbol is created. The control unit 100 interprets the symbol created in the contact area 103, 105 for symbol creation, and said created symbol is displayed on the touch screen 106 in the form of composed text.

In an embodiment of the invention, the control unit 100 detects the start of the symbol creation function, and as a result, the control unit 100 enlarges 105 the contact area 103 for symbol creation. The control unit 100 then interprets the symbol created on the enlarged contact area 105 for symbol creation. The enlarged contact area 105 for symbol creation includes not only the original contact area 103, but also part of the area surrounding the original contact area 103. Herein, the original contact area 103 refers to the not yet enlarged contact area 103 for symbol creation. The start of the symbol creation function is detected for instance based on a touch on the contact area 103 for symbol creation. Alternatively, the start of symbol creation is detected by means of a start signal given with a separate signalling device 112, 106. A touch on the contact area 103, 105 for symbol creation results in the software in the memory of the control unit 100 detecting the start of the symbol creation function, and as a result, the contact area 103 for symbol creation is enlarged. When the symbol is now created in the enlarged contact area 105 for symbol creation, a larger area is usable for symbol creation than before the enlargement. The symbol to be created does not necessarily have to be entirely on the contact area that was interpreted as the contact area for symbol creation before the symbol creation function was started. Naturally, to be interpreted, the symbol to be created can be entirely in the contact area intended for symbol creation that is not in the additional area provided by the enlargement of the contact area.

The contact area for symbol creation is enlarged in the area of the touch screen 106 in predetermined directions after the start of the symbol creation function. The enlargement is carried out for instance by enlarging the contact area for symbol creation equally far in each given direction. Consequently, the contact area for symbol creation is larger than previously, which considerably facilitates symbol creation. How much the contact area for symbol creation is enlarged after the start of symbol creation depends for instance on settings made by the user or by the manufacturer of the device. The size of the contact area for symbol creation is enlarged for instance equally in every direction. The enlarged contact area for symbol creation is for instance at least 25% larger than the contact area for symbol creation before the symbol creation function was started. If the contact area for symbol creation is located for instance at an edge or in a corner of the touch screen 106, the contact area for symbol creation is enlarged for instance only in the directions where the edges of the touch screen 106 are not met. Not only the edges, but also other active areas on the touch screen 106, such as an Internet window, may prevent the enlargement.

In an embodiment of the invention, a signal may be given at the start of the symbol creation function. Said signal is given to indicate the location or size of the enlarged contact area 105 on the enlarged contact area 105. Such a signal may be a light, voice or vibration signal, for example. A light signal, for example, illuminates the contact area 103, 105 for symbol creation and remains illuminated to indicate remaining on the contact area 103, 105. On the other hand, if the contact point moves outside the enlarged contact area 105 for symbol creation during symbol creation, the light signalling is interrupted to indicate that the contact point drifted outside the enlarged contact area 105 for symbol creation. In addition to a light signal, other signals can be predetermined to indicate, for instance remaining in the contact area 103, 105 for symbol creation. Signalling can also be combined as part of different user profiles specified by the user for instance such that in a given user profile a sound signal is given as the result of the start of the symbol creation function, and in some other user profile, a light signal is given as a signal of successful symbol creation.

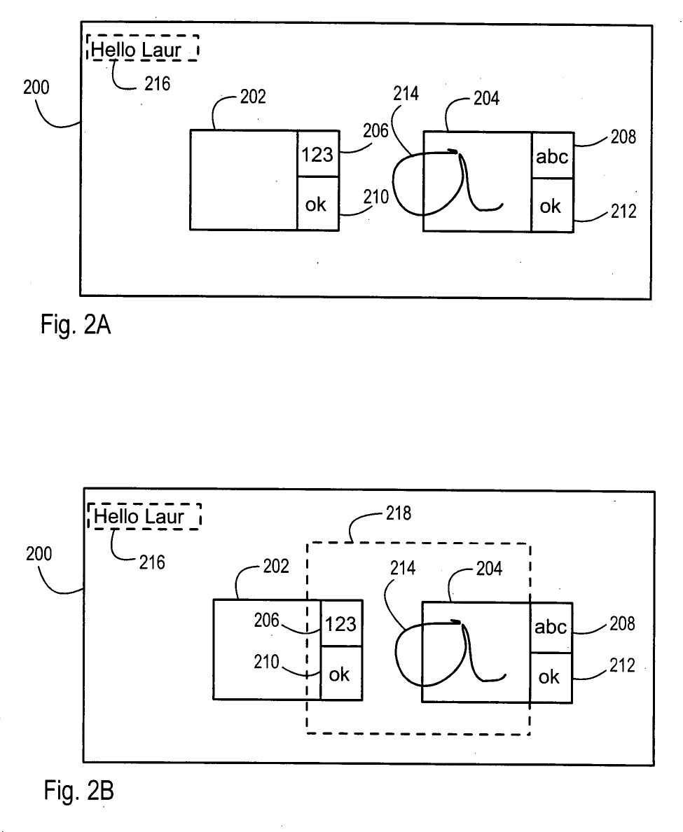

Let us next study examples of solutions of the invention by means of FIGS. 2A and 2B. FIGS. 2A and 2B show a screen 200 of a portable electronic device, such as a PDA device. At least part of the screen area 200 is a contact surface. Contact areas 202, 204 are arranged in the area of the contact surface of the screen 200 for symbol creation. In the identification of written text, the contact areas 202, 204 for symbol creation act such that the desired symbol is created in said contact areas 202, 204 for symbol creation, and based on it, the control unit identifies the symbol and displays it in the form of composed text on the screen 200. Symbols are created by means of a pen or a finger, for example. A symbol, in turn, is one or more letters, digits, images or a combination thereof including two or more symbols. A combination of two or more symbols refers to a symbol including for instance one of the following combinations in any order: letter and digit, letter and image, or digit and image. In practice, in the device, symbols are identified for instance by comparing the detected contact points with data in the memory of the control unit on the symbol that the touching of said contact points represents. To increase identification accuracy, various adaptation methods can be used, by means of which the device is instructed to identify for instance the individual handwriting of its main user.

In the examples shown in FIGS. 2A and 2B, the handwriting identification function operates such that numeric symbols are created one by one in the contact area 202 for digit creation, and letters, in turn, are created in the contact area 204 for letter creation. Alternatively, all symbols are created in the same contact area 202, 204 for symbol creation. Once a symbol is created in the contact area 202, 204 for symbol creation, the device operates such that when the symbol is interpreted, the originally handwritten symbol is displayed in the form of composed text on the screen 200. In FIGS. 2A and 2B, the composed text is illustrated in the area 216 outlined by dashed lines. The device detects the start of the symbol creation function for instance when the user touches the contact area 202, 204 for symbol creation. Alternatively, the user gives a start signal with a signalling device, indicating the start of the symbol creation function. The start signal can be given for instance by touching a start signal area 206, 208 on the screen 200 or in the contact area 202, 204 for symbol creation. To write letters, for example, one touches the start signal area 208 of the contact area 204 for letter creation. To write digits, in turn, one touches the start signal area 206 of the contact area 202 for digit creation. The examples of FIGS. 2A and 2B also include separate acknowledgement areas 210, 212; and by touching these, the user gives a command to end the symbol creation function. Having received the end command, the control unit identifies the created symbol based on the touches it detected and the data in its memory.

Although the screen 200 in FIGS. 2A and 2B does not include other objects than the contact areas 202, 204 for symbol creation, the screen 200 may also include contact areas that relay control commands to the device when being touched. This is also a reason why the contact areas 202, 204 for symbol creation must not take up unreasonably much space on the screen 200. In the example of FIG. 2A, when a user starts symbol creation, for example by using a pen to write the letter ‘a’ 214, the case is often that the entire letter ‘a’ 214 does not fit the contact area 204 for symbol creation. FIG. 2A shows how the letter ‘a’ 214 partially extends outside the contact area 204 for symbol creation. In such a case, the identification of the symbol, herein the letter ‘a’, fails, since the control unit is unable to interpret the parts of the created symbol that are not within the contact area 204 for symbol creation.

In the solution of the invention, the size of the contact area for symbol creation is enlarged and the created symbol is interpreted in an expanded contact area for symbol creation. Accordingly, for instance in the case shown in FIG. 2B, the size of the contact area 204 for symbol creation is enlarged after the start of the symbol creation function is detected. In FIG. 2B, the expanded contact area 218 for symbol creation is illustrated by the area 218 outlined with dashed lines. Although the contact area 204 for symbol creation is enlarged, no larger contact area for symbol creation is necessarily actually shown on the screen. All the control unit does is to interpret the contact area for symbol creation as larger than prior to the start of the symbol creation function. Alternatively, the screen 200 may also visually display the new outlines 218 of the expanded contact area for symbol creation. A signal, such as a light signal, may also be displayed on the expanded contact area for symbol creation when the contact point does not move outside said expanded contact area for symbol creation during symbol creation.

Although in the example of FIG. 2B, part of the letter ‘a’ created in the contact area 204 for symbol creation extends outside the contact area 204 for symbol creation as it was prior to the start of symbol creation, the letter ‘a’ is still within the expanded contact area 218 for symbol creation, and symbol identification succeeds. In the example of FIG. 2B, the expanded contact area 218 for symbol creation extends over the other contact area 202 for symbol creation. After the symbol creation function is completed, the expanded contact area 218 for symbol creation is restored to the same size as it was before the symbol creation function was started.

Once a symbol is created in the expanded contact area 218 for symbol creation, the user of the device may for instance touch the acknowledgement area 212, and the control unit identifies the touching of said acknowledgement area 212 as a command to end the symbol creation function. It is also feasible that when no more touches are detected in the contact area for symbol creation within a given predetermined time, the control unit interprets it as a command to end the symbol creation function. Based on the end command, the expanded contact area for symbol creation is restored to the same size as it was before the symbol creation function was started. Next, if desired, the user is able to restart the symbol creation function for instance by touching any contact area 202, 204 for symbol creation.

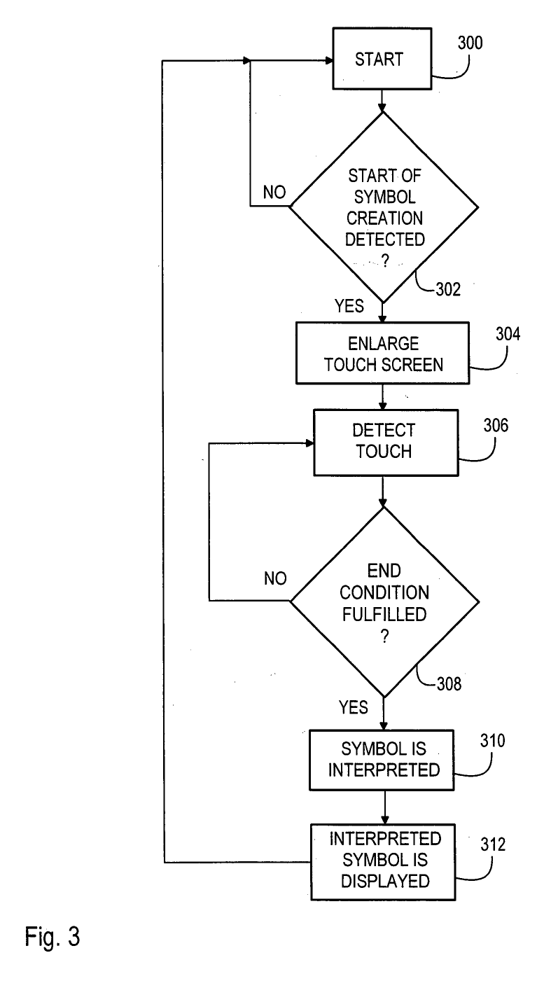

Let us next study an embodiment of the invention by means of FIG. 3. FIG. 3 shows a block diagram of a symbol identification method. In step 300, the device is in an initial state allowing the start of the symbol creation function for instance by a touch on the screen or a contact area for symbol creation in the screen area. Alternatively, the symbol creation function can be started by giving a start signal with a special signalling device. Such a signalling device may be for instance a separate keypad, provided the device comprises a keypad, and the start signal is for instance the depression of a given key or keys on the keypad. The signalling device may also be the screen itself or a start signal area specified in the screen area, the touching of which starts the symbol creation function. The start signal area may be for instance in the contact area for symbol creation.

In step 302, the control unit monitors the state of the screen. If the control unit detects the start of the symbol creation function, based for instance on a start signal given with a signalling device, step 304 is entered, where the size of the contact area for symbol creation is enlarged. In step 304, the size of the contact area for symbol creation is enlarged to a given size based on predetermined settings. The contact area for symbol creation may thus be enlarged more for a weak-sighted main user of the device than for a user with normal eyesight.

Next, in step 306, the control unit detects the touching, i.e. the creation of a symbol in the enlarged contact area for symbol creation. The creation of the symbol can be displayed in the contact area for symbol creation based on the location of the detected contact points. The locations of the contact points of the touches on the contact area for symbol creation are stored in the memory of the control unit.

In step 308, the control unit monitors the fulfilment of the end condition of the symbol creation function. If the fulfilment of the end condition is not detected, the process remains in step 306. The end condition of the symbol creation function is fulfilled when the control unit detects an end command. The end command is given for instance by a touch on a given contact area for giving the end command. Alternatively, the end condition is fulfilled if no more touches are detected in the contact area for symbol creation within a given time. When the fulfilment of the end condition is detected in step 308, step 310 is entered, where the control unit interprets the symbol created in the enlarged contact area. In step 310, the expanded contact area for symbol creation is restored to the same size as it was before the symbol creation function was started. Once the control unit has interpreted the created symbol, step 312 is entered, where the symbol is displayed on the screen in the form of composed text. The initial step 300 is then entered, where the symbol creation function may be restarted.

Although the invention is described above with reference to the example according to the accompanying drawings, it is apparent that the invention is not limited thereto, but can be modified in a variety of ways within the scope of the inventive idea disclosed in the attached claims.

1. A method of identifying symbols in a portable electronic device comprising: a screen, a contact surface in the screen area covering at least part of the screen area, and a contact area for symbol creation located in the contact surface area, the method comprising:
detecting the start of a symbol creation function;
enlarging the size of the contact area for symbol creation after the start of the symbol creation function;
interpreting a symbol created in the enlarged contact area for symbol creation.

2. A method as claimed in claim 1, the method further comprising detecting the start of the symbol creation function based on a touch in the contact area for symbol creation.

3. A method as claimed in claim 1, the method further comprising detecting the start of the symbol creation function based on a start signal given with a signalling device.

4. A method as claimed in claim 1, the method further comprising enlarging the size of the contact area for symbol creation in the screen area by at least 25 percent.

5. A method as claimed in claim 1, the method further comprising detecting the fulfilment of an end condition and interpreting the symbol created in the enlarged contact area for symbol creation once the fulfilment of the end condition is detected.

6. A method as claimed in claim 5, wherein the symbol creation function end condition being fulfilled when an end command is detected.

7. A method as claimed in claim 5, wherein the symbol creation function end condition being fulfilled when no touch is detected in the contact area for symbol creation within a given time.

8. A method as claimed in claim 1, the method further comprising giving a signal at the start of the symbol creation function.

9. A method as claimed in claim 8, the method further comprising giving said signal for indicating the location of the enlarged contact area for symbol creation in the enlarged contact area for symbol creation.

10 A method as claimed in claim 8, wherein said signal is a light, voice or vibration signal.

11. A method as claimed in claim 8, the method further comprising interrupting the signalling if the touch moves outside the enlarged contact area for symbol creation.

12. A method as claimed in claim 1, wherein said symbol is one or more letters, digits, images or a combination thereof including two or more symbols.

13. A portable electronic device comprising: a screen, a contact surface in the screen area covering at least part of the screen area, and a contact area for symbol creation located in the contact surface area, the device comprising means for:
detecting the start of a symbol creation function;
enlarging the size of the contact area for symbol creation after the start of the symbol-creation function;
interpreting a symbol created in the enlarged contact area for symbol creation.

14. A device as claimed in claim 13, further comprising means for detecting the start of the symbol creation function based on a touch in the contact area for symbol creation.

15. A device as claimed in claim 13, further comprising means for detecting the start of the symbol creation function based on a start signal given with a signalling device.

16. A device as claimed in claim 13, wherein the means for enlarging the size of the contact area for symbol creation are configured to enlarge the size of the contact area based on control given by a touch screen or other user interface comprised by the device.

17. A device as claimed in claim 13, wherein the means for enlarging the size of the contact area for symbol creation are configured to enlarge the size of the contact area for symbol creation in the screen area by at least 25 percent.

18. A device as claimed in claim 13, further comprising means for detecting the fulfilment of an end condition and for interpreting the symbol created in the enlarged contact area for symbol creation once the fulfilment of the end condition is detected.

19. A device as claimed in claim 18, further comprising means for detecting an end command and for detecting the fulfilment of the end condition based on the detection of the end command.

20. A device as claimed in claim 18, further comprising means for detecting the fulfilment of the end condition when no touch is detected in the contact area for symbol creation within a given time.

21. A device as claimed in claim 13, further comprising means for giving a signal at the start of the symbol creation function.

22. A device as claimed in claim 21, further comprising means for giving said signal in the enlarged contact area for symbol creation for indicating the location of the enlarged contact area for symbol creation.

23. A device as claimed in claim 21, wherein said signal is a light, voice or vibration signal.

24. A device as claimed in claim 21, further comprising means for interrupting the signalling if the touch moves outside the enlarged contact area for symbol creation.

25. A device as claimed in claim 13, wherein said symbol is one or more letters, digits, images or a combination thereof including two or more symbols.

26. A device as claimed in claim 13, wherein the portable electronic device is a mobile station.

27. A device as claimed in claim 13, wherein the portable electronic device is a PDA (Personal Digital Assistant) device or a portable computer.

28. A device as claimed in claim 27, further comprising means for establishing a telecommunication connection.

29. A device as claimed in claim 28, wherein the telecommunication connection is a connection to be implemented in a mobile network.

30. A device as claimed in claim 28, wherein the telecommunication connection is an Internet connection.

31. A device as claimed in claim 28, wherein the telecommunication connection is a short-range wireless connection.

32. A device as claimed in claim 31, wherein the short-range wireless connection is a Bluetooth, infrared or WLAN connection.
